(19) United States
(12) Patent Application Publication
(10) Pub. No.: US 2025/0236458 A1
(43) Pub. Date: Jul. 24, 2025

(54) DYNAMIC TUNING OF DIG-DOWN

(71) Applicant: AutoStore Technology AS, Nedre Vats (NO)

(72) Inventors: Vegard Syre-Aaker, Asker (NO); Rune Brattbakk Bilit, Asker (NO)

(21) Appl. No.: 18/881,859

(22) PCT Filed: Jul. 3, 2023
(86) PCT No.: PCT/EP2023/068194

§ 371 Date: Jan. 7, 2025

(30) Foreign Application Priority Data
Jul. 8, 2022 (NO) 20220787

(51) Int. Cl. B65G 1/04; B65G 1/137

(52) U.S. Cl. CPC B65G 1/0464; B65G 1/0478; B65G 1/0492; B65G 1/1378

(57) ABSTRACT

A method and system for optimizing the time used for clearing up after digging for containers in a grid of an automated storage and retrieval system, the grid comprising a grid-based rail system being part of a framework structure wherein the rail system comprises a first set of parallel rails arranged to guide movement of container handling vehicles in a first direction (X) across the top of the framework structure, and a second set of parallel rails arranged perpendicular to the first set of rails to guide movement of the container handling vehicle in a second direction (Y) which is perpendicular to the first direction (X), the first and second sets of parallel rails dividing the rail system into a plurality of cells, the framework structure comprising upright members that define storage columns for storing containers within the framework structure, a central computer system with an Assigner program for assigning tasks to container handling vehicles is configured to calculate the method comprising: the central computer system calculates the hole percent of the automated storage and retrieval system, the central computer system provides information regarding the density of container handling vehicles on the grid, the central computer system provides information regarding the working space, using at least one of the parameters hole percent, density of container handling vehicles on the grid and/or the working space for calculating in the assigner part of the central computer system how much resources should be used for cleaning up after digging for containers in the storage and retrieval unit.

### FIELD OF THE INVENTION

The present invention relates to an automated storage and retrieval system for storage and retrieval of containers, in particular to a system and method for adjusting the resources used for cleaning up after having been digging after a container buried down in the columns.

### BACKGROUND AND PRIOR ART

FIG. 1 discloses a typical prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as containers, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201,301,401 comprises a vehicle body 201a,301a,401a and first and second sets of wheels 201b,301b,201c,301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b,301b,201c,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2.

Conventionally, and also for the purpose of this application, Z=1 identifies the uppermost layer of storage containers, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

When a container handling vehicle is digging up a column in order to get access to a container stored towards the bottom of the column, the containers stored above the container in question are placed around the column where the digging is taking placed.

After the dig up, the container handling vehicle places the containers back in place before transporting the container in question to a port.

This cleaning up takes a lot of time away from the main target of the system which is to deliver containers to the ports in order for the items to be picked from them. There is therefore a benefit of adjusting the time spent on clearing up after a digging and rather spend the time transporting the container to the port. However, clearing up is necessary to keep the ordering of the containers in the stack. In addition, delaying clearing up will complicate further digging in the same area.

In the current state of the art system there is no way of solving this problem.

### SUMMARY OF THE INVENTION

The present invention is set forth and characterized in the independent claims, while the dependent claims describe other characteristics of the invention.

In one aspect, the invention is related to a method for optimizing the time used for clearing up after digging for containers in a grid of an automated storage and retrieval system, the grid comprising a grid-based rail system being part of a framework structure wherein the rail system comprises a first set of parallel rails arranged to guide movement of container handling vehicles in a first direction (X) across the top of the framework structure, and a second set of parallel rails arranged perpendicular to the first set of rails to guide movement of the container handling vehicle in a second direction (Y) which is perpendicular to the first direction (X), the first and second sets of parallel rails dividing the rail system into a plurality of cells, the framework structure comprising upright members that define storage columns for storing containers within the framework structure, a central computer system with an Assigner program for assigning tasks to container handling vehicles is configured to calculate the method comprising: the central computer system calculates the hole percent of the automated storage and retrieval system, the central computer system provides information regarding the density of container handling vehicles on the grid, the central computer system provides information regarding the working space, using at least one of the parameters hole percent, density of container handling vehicles on the grid and/or the working space for calculating in the assigner part of the central computer system how much resources should be used for cleaning up after digging for containers in the storage and retrieval unit.

Further the invention may include adjusting for time of day when calculating the number of container handling vehicles used for clearing up after digging for containers, also it may include adjusting for height of stack when calculating the number of container handling vehicles used for clearing up after digging for containers.

Also, the invention may include adjusting for number of picking orders when calculating the number of container handling vehicles used for clearing up after digging for containers.

The Assigner may reduce the number of container handling vehicles used for clearing up after digging for containers if working space is large on the storage and retrieval system.

The Assigner may increase the number of container handling vehicles used for clearing up after digging for containers if working space is small on the storage and retrieval system.

The invention may use working space to tune the resources used for cleaning up the grid after digging for a container or the hole percent to tune the resources used for cleaning up the grid after digging for a container or the robot density to tune the resources used for cleaning up the grid after digging for a container.

The second aspect of the invention is related to a system for optimizing the time used for clearing up after digging for containers in a grid of an automated storage and retrieval system, the grid comprising a grid-based rail system being part of a framework structure, the rail system comprising a first set of parallel rails arranged to guide movement of container handling vehicles in a first direction (X) across the top of the framework structure, and a second set of parallel rails arranged perpendicular to the first set of rails to guide movement of the container handling vehicle in a second direction (Y) which is perpendicular to the first direction (X), the first and second sets of parallel rails dividing the rail system into a plurality of grid cells, the framework structure comprising upright members that define storage columns for storing containers within the framework structure wherein, an Assigner for assigning tasks to container handling vehicles is configured to calculate the number of container handling vehicles used for clearing up after digging for containers, calculate the working space for the container handing vehicles using (density of container handling vehicles on the grid)*(number of free spaces/number of grid cells).
the Assigner in the central computer system assigns fewer container handling vehicles used for clearing up after digging for containers when working space increases over time.
the Assigner in the central computer system assigns more container handling vehicles used for clearing up after digging for containers if working space decreases.

A third aspect of the invention regards a computer program product comprising instructions which when run on a computer causes the Assigner to perform the method mentioned in the first aspect of the invention.

The present invention solves the problems mentioned above by allowing the central computer system to allow how much resources should be used for cleaning up after digging for containers in a storage and retrieval system depending on the working space, or even the hole percent or the density of the container handling vehicles on the grid of the storage and retrieval system.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a flow chart of the decisions made by the Assigner regarding the resources used to cleaning up after digging after a container.

FIG. 6 is an alternative solution for using the working space parameter for adjusting the resources used for cleaning up after digging for containers in the storage and retrieval system

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

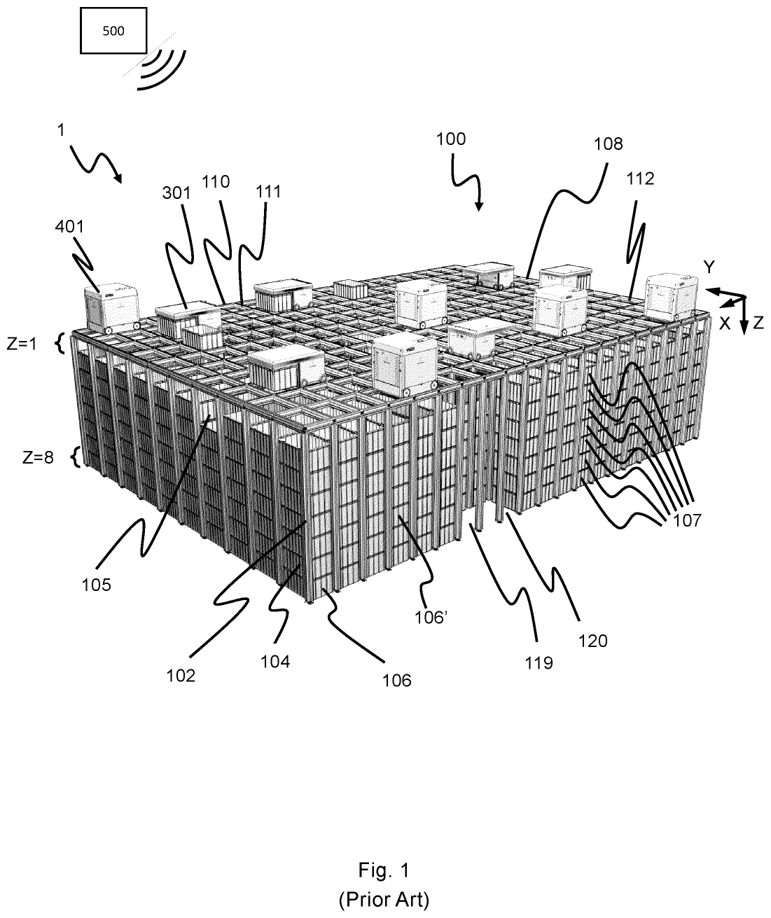

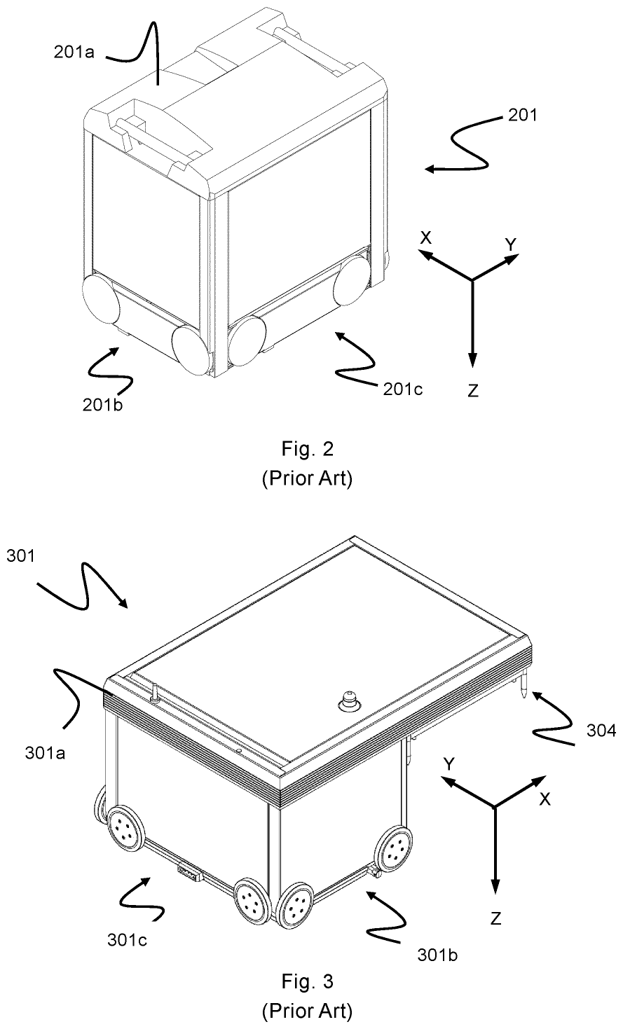

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

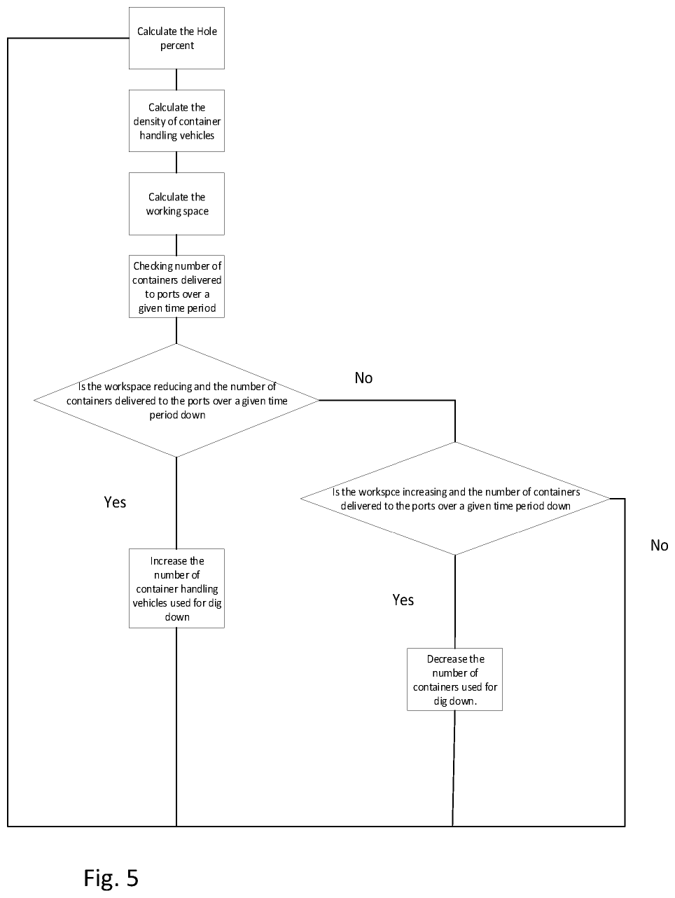

One embodiment of the automated storage and retrieval system according to the invention will now be discussed in more detail with reference to FIG. 5

FIG. 5 is a flow chart of the decisions made regarding the resources used to cleaning up after digging after a container.

In a container storage and retrieval system the container handling vehicle sometimes has to dig up container from the bottom of a stack of containers if the container in question is placed at the bottom of a stack. In order to get to the containers at the bottom the container handling vehicle has to lift all the container above the container in question away in order to get to the bottom one. This is called digging.

The containers that has been lifted up is placed on top of columns of containers around the one that is being dug into.

As the system is today the containers are placed back into the column after the container in question has been dug up before the container in question is transported to the port. This takes a lot of time and effort that is used in cleaning up after digs.

However, it might not be the best use of the capacity of the system to use the time to clean up after a dig. It might be a better use of time to deliver the container to the port and have the container handling vehicle go on to the next job instead of cleaning. The cleaning can be done at a later time when the system is less busy or.

The present invention therefore suggests a solution to how to calculate how much time should be used to clean up (dig down) after a dig up.

The time spent on dig down will have to be calculated for each site or grid. In order to calculate this, we use the hole percent and working space per container handling vehicle as an important characteristic of the grid. Both of these could be used to modify the behaviour of the Router to allow different behaviour for different sites/grids.

In the Assigner we need to choose how many container handling vehicles that we would like to use to drive to port and how many container handling vehicles to use to dig-down.

We can also include number of containers per stack in the decision about how much dig-down to do. The number of containers per stack give an indication of how many free spaces we need to dig up a container.

The Assigner needs to decide which jobs that should be done. In many situations we have the choice between driving containers to port or cleaning up the grid. Dig-down jobs are the most important jobs to clean-up the grid. We should always force some degree of dig-down of containers, to ensure that we have enough space left to dig up other containers. Ordinarily, a storage and retrieval system set the task of cleaning up after a dig higher than the job of transporting the container to the port. This is in order to ensure that the grid is as tidy as possible in order to not lock the area for other dig ups, but also it is not possible to put containers returning from ports in these locations, and we cannot use these cells for anything else while there are temporary containers there (temporary containers are containers that need clean up after digging).

Also, not hinder the movability of the container handling vehicles. However, the time used to clean up after a dig is time lost when it comes to the most important part of the job the system does, which is to finish as many picking orders as possible. There might therefor be preferable to not clean up after a dig and allow some untidiness on the grid in order to make sure that the container is transported to the port as quickly as possible. This will allow the storage and retrieval system to function better by increasing the number of containers that reach the ports.

There is however a plurality of parameters to consider in order to decide how many resources that should be used to cleaning up after digging for a container.

There is the hole percent, the density of container handling vehicles operating on the grid and the working space each container handling vehicle has on the grid.

The hole percent is calculated as the amount of free space divided by the number of cells times 100. This describes how many percent of the grid is filled with containers. As an example, if we on average have 15 containers per stack, but only have enough containers to fill 14 containers per stack, we have a hole percent of 100%. If we on average fill 14.5 containers per stack, we have a hole percent of 50%.

So, a higher hole percent makes it easier to make good dig areas.

The density of container handling vehicles is a calculation of the number of cells divided by the number of container handling vehicles. This describes how dense the grid is with container handling vehicles.

This gives an indication for how much traffic there is, and how many route conflicts there will be between the container handling vehicles.

Working space per container handling vehicle is a calculation of the density of container handling vehicles times the hole percent, and it describes how many cells each container handling vehicle has to do work on (dig, put out of port, etc.).

Having a low working space will force us to make less optimal dig area's and the need to clean up the grid is a priority.

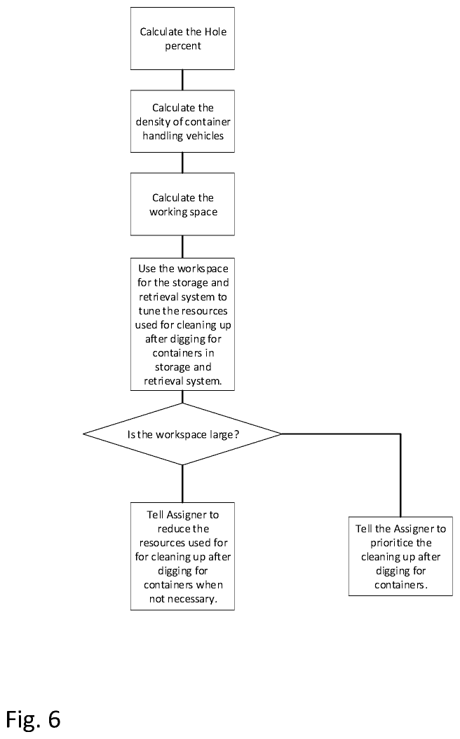

FIG. 6 is an alternative solution for using the working space parameter for adjusting the resources used for cleaning up after digging for containers in the storage and retrieval system to a particular system based on the working space for that system.

Working space is an important parameter since it could be used to tuning many different parameters of the storage and retrieval systems. The different storage and retrieval systems varies in storage capacity and space. There is hence a great difference between a system that has a large working space and a system that has a small working space. It therefore leads to the conclusion that the difference in the ideal running of a system with a large working space and a system with a small working space is quite different. A system with a large working space can allow for a less resources used for cleaning up after digging for containers in the storage and retrieval system. A storage and retrieval system that has a small working space hence has the need for using a lot of resources in cleaning up after digging for containers in the storage and retrieval system. If the system with the small working space did prioritize cleaning up after digging for containers in the storage and retrieval system the working space for the container handling vehicles would become so small that it would slow down the running of the storage and retrieval system. So, the working space could be used to tune different things on a grid e.g. tuning of the cleaning up after digging for containers in the storage and retrieval system.

The working space is relatively constant on a grid but will vary a lot between grid to grid, this is due to the owner of the system usually wants as many containers in a system as possible. This will result in some storage and retrieval systems have a small working space due to many containers in the grid and some storage and retrieval systems have a large working space since the storage and retrieval system is a large one. So, with the same amount of resources used for cleaning up after digging for containers in the storage and retrieval system the working space is relatively constant in a storage and retrieval system, but is would change a lot within that storage and retrieval system. Examples of things that will change the working space is the storage and retrieval system is a robot is taken out to service, a container is added/removed from the system, a robot is sent to charge, etc.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

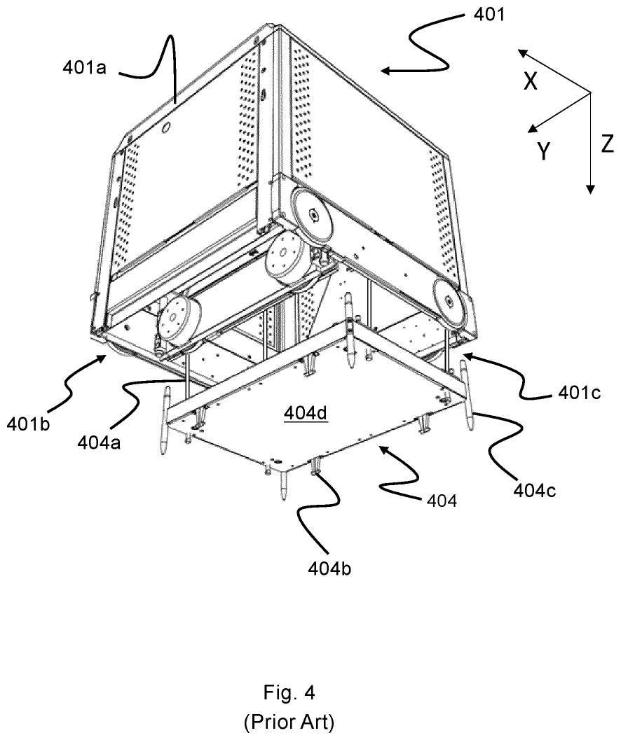

### Prior Art (FIGS. 1-4):

1 Prior art automated storage and retrieval system
100 Framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction

1.-13. (canceled)

14. A method for optimizing time used for clearing up after digging for containers in a grid of an automated storage and retrieval system, the grid comprising a grid-based rail system being part of a framework structure, the rail system divided into a plurality of cells, the framework structure comprising upright members that define storage columns for storing containers within the framework structure, a central computer system with an Assigner program for assigning tasks to container handling vehicles, wherein the Assigner program is configured to calculate the method comprising:
the central computer system calculates a hole percent of the automated storage and retrieval system,
the central computer system provides information regarding a density of container handling vehicles on the grid,
the central computer system provides information regarding a working space,
using at least one of the hole percent, the density of container handling vehicles on the grid, or the working space for calculating in an assigner part of the central computer system how much resources should be used for cleaning up after digging for containers in a storage and retrieval unit.

15. The method according to claim 14, wherein the rail system comprises a first set of parallel rails arranged to guide movement of container handling vehicles in a first direction (X) across a top of the framework structure, and a second set of parallel rails arranged perpendicular to the first set of rails to guide movement of the container handling vehicle in a second direction (Y) which is perpendicular to the first direction (X).

16. The method according to claim 14, wherein the method includes adjusting for time of day when calculating a number of container handling vehicles used for clearing up after digging for containers.

17. The method according to claim 14, wherein the method includes adjusting for height of stack when calculating a number of container handling vehicles used for clearing up after digging for containers.

18. The method according to claim 14, wherein the method includes adjusting for number of picking orders when calculating a number of container handling vehicles used for clearing up after digging for containers.

19. The method according to claim 14, wherein the Assigner program reduces a number of container handling vehicles used for clearing up after digging for containers if a working space on the storage and retrieval system is large.

20. The method according to claim 14, wherein the Assigner program increases a number of container handling vehicles used for clearing up after digging for containers if a working space on the storage and retrieval system is small.

21. The method according to claim 14, further comprising using the working space to tune the resources used for cleaning up the grid after digging for a container.

22. The method according to claim 14, further comprising using the hole percent to tune the resources used for cleaning up the grid after digging for a container.

23. The method according to claim 14, further comprising using robot density to tune the resources used for cleaning up the grid after digging for a container.

24. A system for optimizing time used for clearing up after digging for containers in a grid of an automated storage and retrieval system, the grid comprising a grid-based rail system being part of a framework structure, the rail system divided into a plurality of grid cells, the framework structure comprising upright members that define storage columns for storing containers within the framework structure, wherein an Assigner program for assigning tasks to container handling vehicles is configured to calculate a number of container handling vehicles used for clearing up after digging for containers, calculate a working space for the container handling vehicles using (a density of container handling vehicles on the
$$grid ) * ( \frac{number of free spaces}{number of grid cells} ) .$$

25. The system according to claim 24, wherein the rail system comprises a first set of parallel rails arranged to guide movement of container handling vehicles in a first direction (X) across a top of the framework structure, and a second set of parallel rails arranged perpendicular to the first set of rails to guide movement of the container handling vehicle in a second direction (Y) which is perpendicular to the first direction (X).

26. The system according to claim 24, wherein the Assigner program in a central computer system assigns fewer container handling vehicles used for clearing up after digging for containers when working space increases over time.

27. The system according to claim 24, wherein the Assigner program in a central computer system assigns more container handling vehicles used for clearing up after digging for containers.

28. A computer program product comprising instructions which when run on a computer causes the Assigner program to perform the method of claim 14.
